(19) United States
(12) Patent Application Publication
(10) Pub. No.: US 2025/0390004 A1
(43) Pub. Date: Dec. 25, 2025

(54) DOME CAMERA WITH INFRARED DIFFUSE REFLECTION PREVENTION FUNCTION

(71) Applicant: IDIS CO., LTD., Daejeon (KR)

(72) Inventors: Jin Kyu SONG, Seongnam-si (KR); Min Shic SHIN, Seongnam-si (KR); Jin Seong CHOI, Seongnam-si (KR)

(73) Assignee: IDIS CO., LTD., Daejeon (KR)

(21) Appl. No.: 19/192,401

(22) Filed: Apr. 29, 2025

(30) Foreign Application Priority Data
Jun. 24, 2024 (KR) 10-2024-0082056

(51) Int. Cl. G03B 11/04; G03B 15/03; G03B 17/02

(52) U.S. Cl. CPC G03B 11/045; G03B 15/03; G03B 17/02; G03B 2215/0503; G03B 2215/0567

(57) ABSTRACT

The present invention relates to a dome camera with an IR diffuse reflection prevention function to efficiently prevent infrared (IR) light from being diffusely reflected on an inner circumference of a dome cover and being incident on a lens module and prevent a surveillance direction of the lens module from being changed or an IR diffuse reflection prevention bushing from being deformed by reducing a frictional force between the inner circumference of the dome cover and a front side of the IR diffuse reflection prevention bushing when the dome cover is mounted.

### CROSS-REFERENCE TO RELATED APPLICATION(S)

This application claims priority from Korean Patent Application No. 10-2024-0082056, filed on Jun. 24, 2024 in the Korean Intellectual Property Office, the disclosure of which is incorporated herein by reference in its entirety.

### BACKGROUND

### 1. Field

The following description relates to a dome camera, and more particularly, to a dome camera with an infrared diffuse reflection prevention function.

### 2. Description of Related Art

A dome camera is a camera of which a surveillance direction can be adjusted and which includes a dome cover, which is a transparent dome (hemisphere)-shaped window, to protect the camera from the outside and also allow the camara to capture an image of an entire region even when a pan/tilt operation is performed.

A dome camera may have a horizontal rotation (pan) function, a vertical rotation (tilt) function, and a zoom function for adjusting a magnification, and these functions are called PTZ and used in various products such as a closed-circuit television (CCTV) and video conference cameras, lighting apparatuses, and the like.

In a general dome camera, a surveillance direction of the camera is manually adjusted through an internal gimbal operation, and in a speed dome camera, a surveillance direction of the camera is automatically or remotely adjusted using a motor and a power transmission device.

Such a dome camera may have a function of emitting infrared (IR) light to capture an image not only during the day but also at night. When the dome camera has the IR emitting function, IR light is diffusely reflected on an inner circumference of a dome cover and is incident on a lens module, and thus a problem that a normal image cannot be captured occurs.

Accordingly, the present inventor has conducted research on a dome camera with an IR diffuse reflection prevention function, in which IR light is efficiently prevented from being diffusely reflected on an inner circumference of a dome cover and being incident on a lens module, and a frictional force between the inner circumference of the dome cover and a front side of an IR diffuse reflection prevention bushing when the dome cover is mounted is reduced to prevent a surveillance direction of the lens module from being changed.

### RELATED ART

### Patent Document

Korean Utility Model Registration No. 20-0455617 (Announcement on Sep. 16, 2011)

### SUMMARY

Embodiments of the present invention are directed to providing a dome camera with an infrared (IR) diffuse reflection prevention function, in which IR light is efficiently prevented from being diffusely reflected on an inner circumference of a dome cover and being incident on a lens module, and a frictional force between the inner circumference of the dome cover and a front side of an IR diffuse reflection prevention bushing when the dome cover is mounted is reduced to prevent a surveillance direction of the lens module from being changed or the IR diffuse reflection prevention bushing from being deformed.

In accordance with one aspect of the present invention, there is provided a dome camera with an IR diffuse reflection prevention function, which includes a lens module, a plurality of IR light-emitting diodes which are installed to be spaced apart from each other around an outer circumference of the lens module and emit IR light, a housing in which the lens module is accommodated and mounted and which protects the lens module from the outside, a dome cover mounted to protrude from a front surface of the housing and formed of a transparent material not to block a field of view of the lens module accommodated and mounted in the housing, and an IR diffuse reflection prevention bushing which prevents the IR light emitted by the IR light-emitting diodes and diffusely reflected on an inner circumference of the dome cover from being incident on the lens module, wherein a front side of the IR diffuse reflection prevention bushing is in close contact with the inner circumference of the dome cover, and a rear side of the IR diffuse reflection prevention bushing is inserted and mounted between the lens module and the IR light-emitting diodes.

In accordance with an additional aspect of the present invention, the front side of the IR diffuse reflection prevention bushing in close contact with the inner circumference of the dome cover may be coated with urethane to reduce a frictional force between the inner circumference of the dome cover and the front side of IR diffuse reflection prevention bushing so that a surveillance direction of the lens module is prevented from being changed when the dome cover is mounted.

In accordance with an additional aspect of the present invention, the IR diffuse reflection prevention bushing may include a step which is formed on the rear side of the IR diffuse reflection prevention bushing inserted and mounted between the lens module and the IR light-emitting diodes and prevents the IR diffuse reflection prevention bushing from being separated from the lens module.

### BRIEF DESCRIPTION OF THE DRAWINGS

FIG. 1 shows perspective views illustrating a configuration of a dome camera with an infrared (IR) diffuse reflection prevention function according to one embodiment of the present invention.

FIG. 2 is a cross-sectional view illustrating a configuration of an IR diffuse reflection prevention bushing of the dome camera with an IR diffuse reflection prevention function according to one embodiment of the present invention.

FIG. 3 is a perspective view for describing a pan operation of a lens module of the dome camera with an IR diffuse reflection prevention function according to the present invention.

FIG. 4 is a cross-sectional view illustrating a pan O-ring installed to allow the pan operation of the lens module of the dome camera with an IR diffuse reflection prevention function to be easily performed according to the present invention.

FIG. 5 is a perspective view for describing a tilt operation of the lens module of the dome camera with an IR diffuse reflection prevention function according to the present invention.

FIG. 6 is a cross-sectional view illustrating a tilt O-ring installed to allow the tilt operation of the lens module of the dome camera with an IR diffuse reflection prevention function to be easily performed according to the present invention.

FIG. 7 is a perspective view for describing a rotation operation of the lens module of the dome camera with an IR diffuse reflection prevention function according to the present invention.

FIG. 8 is a cross-sectional view illustrating a rotation O-ring installed to allow the rotation operation of the lens module of the dome camera with an IR diffuse reflection prevention function to be easily performed according to the present invention.

### DETAILED DESCRIPTION

Hereinafter, in order to facilitate understanding and embodiment by those skilled in the art, the present invention will be described in detail by describing exemplary embodiments with reference to the accompanying drawings. Although specific embodiments are illustrated in the drawings and detailed explanations are described, the embodiments are not intended to limit embodiments of the present invention to the specific forms.

In the description of the invention, when it is determined that detailed descriptions of related well-known functions or configurations unnecessarily obscure the gist of the invention, the detailed descriptions thereof will be omitted.

It will be understood that when a first component is referred to as being “connected” or “coupled” to a second component, the first component may be directly connected or coupled to the second component, or a third component may be interposed therebetween.

In contrast, it will be understood that when a first component is referred to as being “directly connected” or “directly coupled” to a second component, there are no intervening components.

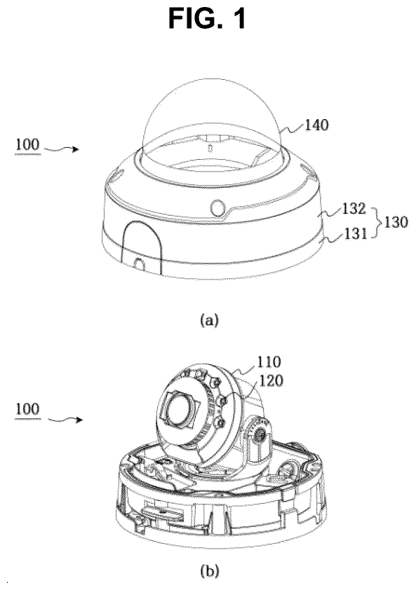

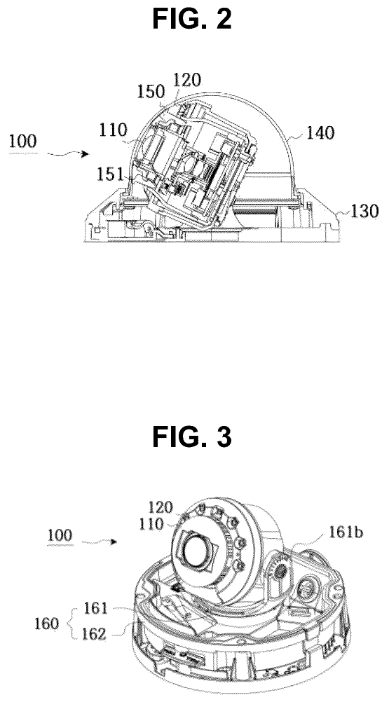

FIG. 1 shows perspective views illustrating a configuration of a dome camera with an infrared (IR) diffuse reflection prevention function according to one embodiment of the present invention, and FIG. 2 is a cross-sectional view illustrating a configuration of an IR diffuse reflection prevention bushing of the dome camera with an IR diffuse reflection prevention function according to one embodiment of the present invention.

As illustrated in FIGS. 1 and 2, a dome camera 100 with an IR diffuse reflection prevention function according to the present invention includes a lens module 110, a plurality of IR light-emitting diodes 120, a housing 130, a dome cover 140, and an IR diffuse reflection prevention bushing 150.

The lens module 110 includes at least one optical lens, a lens holder which fixes the optical lens, an image sensor which converts an optical signal of an image captured by the optical lens into an electric signal, and a protection cover which protects these components from the outside.

The plurality of IR light-emitting diodes 120 are installed to be spaced apart from each other around an outer circumference of the lens module 110 and emit IR light. The IR light emitted by the plurality of IR light-emitting diodes 120 travels in a direction of a field of view of the lens.

The lens module 110 is accommodated and mounted in the housing 130 and protected from the outside. For example, the housing 130 may include a rear housing 131 and a front housing 132 and be formed of an insulating material such as plastic.

The dome cover 140 may be mounted to protrude from a front surface of the housing 130 and formed of a transparent material not to block a field of view of the lens module 110 accommodated and mounted in the housing.

The IR diffuse reflection prevention bushing 150 prevents IR light emitted by the IR light-emitting diodes 120 and diffusely reflected on an inner circumference of the dome cover 140 from being incident on the lens module 110. In this case, a material of the IR diffuse reflection prevention bushing 150 may be a silicon material.

Meanwhile, a front side of the IR diffuse reflection prevention bushing 150 may be formed in close contact with the inner circumference of the dome cover 140, a rear side thereof may be formed to be inserted and mounted between the lens module 110 and the IR light-emitting diodes 120, and thus an IR light emission region to which the IR light is emitted and a light incidence region in which light is incident on the lens module may be spatially spaced apart from each other.

As implemented like this, in the present invention, since the IR light emission region to which the IR light is emitted and the light incidence region in which the light is incident on the lens module are spatially spaced apart from each other using the IR diffuse reflection prevention bushing 150 mounted between the lens module 110 and IR light-emitting diodes 120, the IR light can be efficiently prevented from being diffusely reflected on the inner circumference of the dome cover 140 and being incident on the lens module 110.

Meanwhile, in accordance with an additional aspect of the present invention, as the front side of the IR diffuse reflection prevention bushing 150 in close contact with the inner circumference of the dome cover 140 may be coated with urethane, the frictional force between the inner circumference of the dome cover 140 and the front side of the IR diffuse reflection prevention bushing 150 when the dome cover 140 is mounted may be reduced, and thus the field of view of the lens module 110 may be prevented from being changed.

In a process of installing the dome camera 100 with an IR diffuse reflection prevention function, since a user should adjust a surveillance direction of the lens module 110 and then mount the dome cover 140, a problem that the surveillance direction is changed due to friction between the inner circumference of the dome cover 140 and the front side of the IR diffuse reflection prevention bushing 150 occurs.

In addition, a phenomenon in which the IR diffuse reflection prevention bushing 150 is crushed and deformed due to the friction between the inner circumference of the dome cover 140 and the front side of the IR diffuse reflection prevention bushing 150 and blocks the field of view of the lens module 110 may also occur.

However, in the present invention, since the front side of the IR diffuse reflection prevention bushing 150 in close contact with the inner circumference of the dome cover 140 is coated with urethane to reduce the frictional force between the inner circumference of the dome cover and the front side of the IR diffuse reflection prevention bushing when the dome cover is mounted to prevent the surveillance direction of the lens module from being changed or the IR diffuse reflection prevention bushing from being deformed, a surveillance region error due to the change in surveillance direction of the lens module or a field of view blocking phenomenon due to the deformation of the IR diffuse reflection prevention bushing can be prevented.

Meanwhile, in accordance with an additional aspect of the present invention, the IR diffuse reflection prevention bushing 150 may include a step 151 which is formed on the rear side of the IR diffuse reflection prevention bushing 150 inserted and mounted between the lens module 110 and the IR light-emitting diodes 120 and prevents the IR diffuse reflection prevention bushing 150 from being separated from the lens module 110.

With this implementation, in the present invention, since the step 151 formed on the rear side of the IR diffuse reflection prevention bushing 150 serves as a hook when the IR diffuse reflection prevention bushing 150 is inserted and mounted between the lens module 110 and the IR light-emitting diodes 120, the IR diffuse reflection prevention bushing 150 may be prevented from being separated from the lens module 110, and thus a stable IR diffuse reflection prevention function can be maintained.

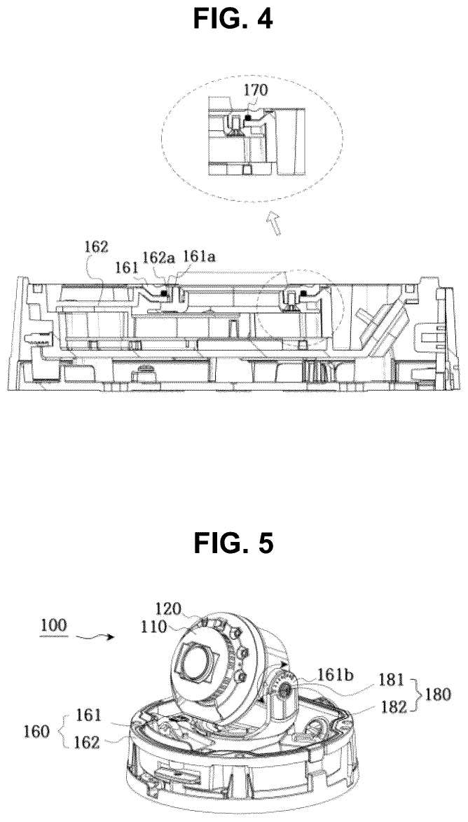

FIG. 3 is a perspective view for describing a pan operation of the lens module of the dome camera with an IR diffuse reflection prevention function according to the present invention, and FIG. 4 is a cross-sectional view illustrating a pan O-ring installed to allow the pan operation of the lens module of the dome camera with an IR diffuse reflection prevention function to be easily performed according to the present invention.

As illustrated in FIGS. 3 and 4, the dome camera 100 with an IR diffuse reflection prevention function according to the present embodiment may include a pan driver 160 and a pan O-ring 170 for easily performing the pan operation of the lens module 110.

The pan driver 160 may be a component for the pan operation of the lens module 110 and include a bracket 161 which fixedly supports the lens module 110 and a base body 162 on which a cylindrical lower portion 161a of the bracket 161 is axially installed.

When the user holds the bracket 161, of which the cylindrical lower portion 161a is axially installed on the base body 162, in their hand and horizontally rotates the bracket 161 left and right, the bracket 161 is horizontally rotated left and right, and the lens module 110 fixedly supported by the bracket 161 horizontally rotated left and right is horizontally rotated left and right with the bracket 161 to perform the pan operation.

In this case, as an outer circumference of the cylindrical lower portion 161a of the bracket 161, of which the cylindrical lower portion 161a is axially installed on the base body 162, and an inner circumference of an axial installation groove 162a of the base body 162 coupled to the outer circumference to correspond thereto are implemented as sawtooth structures, the lens module 110 may be implemented such that a posture thereof is maintained without shaking in a state in which the lens module 110 is controlled for the pan operation even when the user manually controls the lens module 110 for the pan operation.

The pan O-ring 170 allows the lens module 110, of which the pan operation is driven by the pan driver 160, to pan smoothly. For example, the pan O-ring 170 may be installed on a contact portion of the base body 162 and the bracket 161 axially installed thereon. In this case, as a surface of the pan O-ring 170 is coated with urethane, the lens module 110 driven for the pan operation may be implemented to pan more smoothly.

With this implementation, in the present invention, when the pan operation of the lens module 110 is driven, the pan operation may be smoothly and continuously driven due to the pan O-ring 170, generation of a blind spot may be prevented, the user may also more easily adjust a surveillance direction, and thus the surveillance performance and user convenience can be improved.

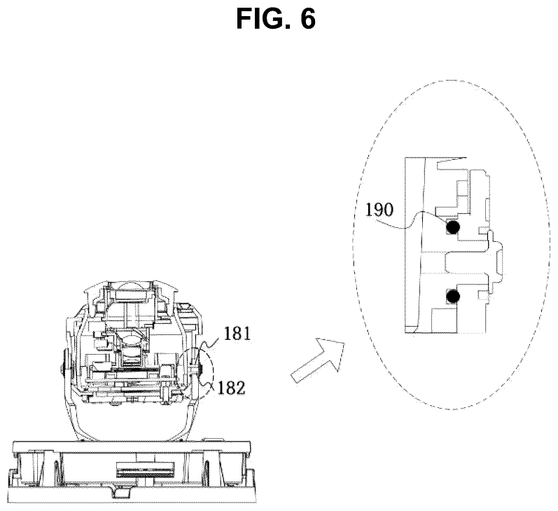

FIG. 5 is a perspective view for describing a tilt operation of the lens module of the dome camera with an IR diffuse reflection prevention function according to the present invention, and FIG. 6 is a cross-sectional view illustrating a tilt O-ring installed to allow the tilt operation of the lens module of the dome camera with an IR diffuse reflection prevention function to be easily performed according to the present invention.

As illustrated in FIGS. 5 and 6, the dome camera 100 with an IR diffuse reflection prevention function according to the present embodiment may include a tilt driver 180 and a tilt O-ring 190 for easily performing the tilt operation of the lens module 110.

The tilt driver 180 may be a component for the tilt operation of the lens module 110 and include circular grooves 181 formed in a pair of protrusions 161b protruding upward from the bracket 161 which fixedly supports the lens module 110 and a pair of lens module coupling parts 182 of which one ends are axially installed in the circular grooves 181 and the other ends are coupled to outer circumferences of both sides of the lens module 110 and which vertically rotate upward and downward.

When the user holds the lens module 110, of which the outer circumferences are coupled to the pair of lens module coupling parts 182 axially installed in the circular grooves 181 formed in the pair of protrusions 161b protruding upward from the bracket 161, in their hand and vertically rotates the lens module 110 upward and downward, the lens module 110 is driven for the tilt operation.

In this case, as inner circumferences of the circular grooves 181 formed in the pair of protrusions 161b protruding upward from the bracket 161 and outer circumferences of one ends of the pair of lens module coupling parts 182 axially installed to correspond thereto are implemented as sawtooth structures, the lens module 110 may be implemented such that a posture thereof is maintained without shaking in a state in which the lens module 110 is controlled for the tilt operation even when the user manually controls the lens module 110 for the tilt operation.

The tilt O-ring 190 allows the lens module 110, of which the tilt operation is driven by the tilt driver 180, to tilt smoothly. For example, the tilt O-ring 190 may be installed on a contact portion of each of the circular grooves 181 formed in the pair of protrusions 161b protruding upward from the bracket 161 and the lens module coupling parts 182 axially installed thereon. In this case, as a surface of the tilt O-ring 190 is coated with urethane, the lens module 110 driven for the tilt operation may be implemented to tilt more smoothly.

With this implementation, in the present invention, when the tilt operation of the lens module 110 is driven, the tilt operation may be smoothly and continuously driven due to the tilt O-ring 190, generation of a blind spot may be prevented, the user may also more easily adjust a surveillance direction, and thus the surveillance performance and user convenience can be improved.

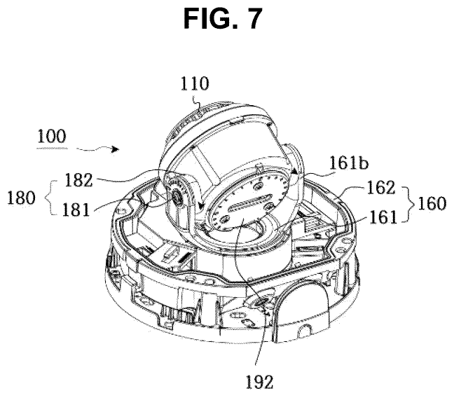

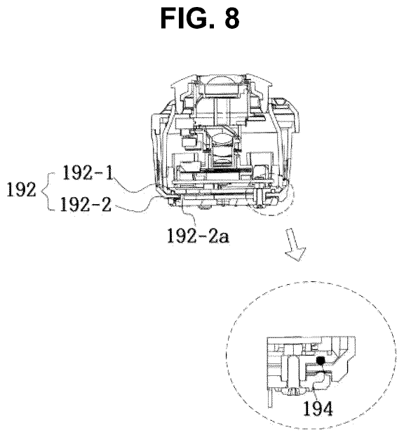

FIG. 7 is a perspective view for describing a rotation operation of the lens module of the dome camera with an IR diffuse reflection prevention function according to the present invention, and FIG. 8 is a cross-sectional view illustrating a rotation O-ring installed to allow the rotation operation of the lens module of the dome camera with an IR diffuse reflection prevention function to be easily performed according to the present invention.

As illustrated in FIGS. 7 and 8, the dome camera 100 with an IR diffuse reflection prevention function according to the present embodiment may include a rotation driver 192 and a rotation O-ring 194 for easily performing the rotation operation of the lens module 110.

The rotation driver 192 may be a component for the rotation operation of the lens module 110 and include a rear coupling groove 192-1 formed in a rear surface of the housing 130 formed to externally surround the protection cover, which protects the lens module 110 at the outside, and a rear bracket 192-2 which is coupled to a rear surface of the protection cover of the lens module 110 through screw coupling or the like and in which an annular protrusion 192-2a protruding from a front surface of the rear bracket 192-2 is coupled to the rear coupling groove 192-1 and rotated with the lens module 110.

When the user holds the lens module 110 in their hand and rotates the lens module 110 left and right, the lens module 110 and the rear bracket 192-2 fixedly coupled thereto are rotated in the rear coupling groove 192-1, so that the lens module 110 is driven for the rotation operation.

In this case, as an inner circumference of the rear coupling groove 192-1 formed in the rear surface of the housing 130 formed to externally surround the protection cover, which protects the lens module 110 from the outside, and an outer circumference of the annular protrusion 192-2a of the rear bracket 192-2 are implemented as sawtooth structures, the lens module 110 may be implemented such that a posture thereof is maintained without shaking in a state in which the lens module 110 is controlled for the rotation operation even when the user manually controls the lens module 110 for the rotation operation.

The rotation O-ring 194 allows the lens module 110, of which the rotation operation is driven by the rotation driver 192, to rotate smoothly. For example, the rotation O-ring 194 may be installed on a contact portion of an outer side of the rear surface of the protection cover, which protects the lens module 110 from the outside, and an inner side of the rear surface of the housing 130 formed to surround the protection cover from the outside. In this case, as a surface of the rotation O-ring 194 is coated with urethane, the lens module 110 driven for the rotation operation may be implemented to rotate more smoothly.

With this implementation, in the present invention, when the rotation operation of the lens module 110 is driven, the rotation operation may be smoothly and continuously driven due to the rotation O-ring 194, and thus the user convenience can be improved.

As described above, since the present invention can efficiently prevent IR light from being diffusely reflected on the inner circumference of the dome cover and being incident on the lens module and prevent a surveillance direction of the lens module from being changed or the IR diffuse reflection prevention bushing from being deformed by reducing a frictional force between the inner circumference of the dome cover and the front side of the IR diffuse reflection prevention bushing when the dome cover is mounted, a surveillance region error due to the change in surveillance direction of the lens module or a field of view blocking phenomenon due to the deformation of the IR diffuse reflection prevention bushing can be prevented.

Since the present invention can efficiently prevent IR light from being diffusely reflected on an inner circumference of a dome cover and being incident on a lens module and reduce a frictional force between the inner circumference of the dome cover and a front side of an IR diffuse reflection prevention bushing so that a surveillance direction of the lens module is prevented from being changed or the IR diffuse reflection prevention bushing is prevented from being deformed when the dome cover is mounted, there is an effect of preventing a surveillance region error due to the change in surveillance direction of the lens module or a field of view blocking phenomenon due to the deformation of the IR diffuse reflection prevention bushing.

Various embodiments disclosed in this specification and drawings are only specific examples to aid in understanding of the invention and are not intended to limit the scope of various embodiments of the present invention.

Accordingly, the scope of various embodiments of the present invention should not be limited by the above-described embodiments, and all changes or modifications derived from the technical ideas of various embodiments of the present invention should be construed as being included in the scope of various embodiments of the present invention.

### INDUSTRIAL APPLICABILITY

The present invention can be industrially used in the technology field related to a dome camera and the application technology field thereof.

What is claimed is:

1. A dome camera with an infrared (IR) diffuse reflection prevention function, comprising:
a lens module;
a plurality of IR light-emitting diodes which are installed to be spaced apart from each other around an outer circumference of the lens module and emit IR light;
a housing in which the lens module is accommodated and mounted and which protects the lens module from an outside;
a dome cover mounted to protrude from a front surface of the housing and formed of a transparent material not to block a field of view of the lens module accommodated and mounted in the housing; and
an IR diffuse reflection prevention bushing which prevents the IR light emitted by the IR light-emitting diodes and diffusely reflected on an inner circumference of the dome cover from being incident on the lens module,
wherein a front side of the IR diffuse reflection prevention bushing is in close contact with the inner circumference of the dome cover, and
a rear side of the IR diffuse reflection prevention bushing is inserted and mounted between the lens module and the IR light-emitting diodes.

2. The dome camera of claim 1, wherein the front side of the IR diffuse reflection prevention bushing in close contact with the inner circumference of the dome cover is coated with urethane to reduce a frictional force between the inner circumference of the dome cover and the front side of IR diffuse reflection prevention bushing so that a surveillance direction of the lens module is prevented from being changed when the dome cover is mounted.

3. The dome camera of claim 1, wherein the IR diffuse reflection prevention bushing includes a step which is formed on the rear side of the IR diffuse reflection prevention bushing inserted and mounted between the lens module and the IR light-emitting diodes and prevents the IR diffuse reflection prevention bushing from being separated from the lens module.
